(19) United States
(12) Patent Application Publication
(10) Pub. No.: US 2003/0033443 A1
(43) Pub. Date: Feb. 13, 2003

(54) Virtual machine integration application program interface

(76) Inventor: Nikolay Igotti, Palo Alto, CA (US)

Correspondence Address: J.D. Harriman II, COUDERT BROTHERS, 23rd Floor, 333 South Hope Street, Los Angeles, CA, 90071, US

(21) Appl. No.: 09/797,864

(22) Filed: Mar. 1, 2001

(51) Int. Cl. G06F 9/46

(52) U.S. Cl. 709/328; 709/1

(57) ABSTRACT

The present invention relates to a low-level API for integrating a virtual machine into a host application. According to one or more embodiments of the present invention, the plug-in traditionally used to implement a virtual machine is partitioned into two categories. A first category contains host application specific information. A second category contains host application independent information and contains the virtual machine itself. This allows a developer to interface with the virtual machine in a manner that is removed from the runtime environment that exists in the host application.

### BACKGROUND OF THE INVENTION

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

1. Field of the Invention

The present invention relates to an application program interface (API) for integrating a virtual machine (VM) into a generic application.

2. Background Art

Platform independent programming languages allow a virtual machine to be opened in a host application. The virtual machine creates its own environment within the host application and runs computer programs in its environment without regard to the type of computer system the host application is running. This is useful, for instance, when a person is using the Internet and the virtual machine is opened in a host application such as a web browser. Regardless of the type of host application, however, the virtual machine must be “integrated” into the host application first before programs may be run inside of it. Integration means that the virtual machine must be changed or optimized to operate in the host application or environment. This may require changes to the virtual machine for each different environment in which it is to be used. Virtual machine integration is difficult because host application specific details often must be known by the developer who is integrating the virtual machine.

Before further discussing the drawbacks associated with integrating the virtual machine, an overview of the Internet and platform-independent programming languages is provided.

### Internet

The Internet is a network connecting many computer networks and is based on a common addressing system and communications protocol called TCP/IP (Transmission Control Protocol/Internet Protocol). From its creation it grew rapidly beyond its largely academic origin into an increasingly commercial and popular medium. By the mid- 1990s the Internet connected millions of computers throughout the world. Many commercial computer network and data services also provided at least indirect connection to the Internet.

The original uses of the Internet were electronic mail (e-mail), file transfers (ftp or file transfer protocol), bulletin boards and newsgroups, and remote computer access (telnet). The World Wide Web (web), which enables simple and intuitive navigation of Internet sites through a graphical interface, expanded dramatically during the 1990s to become the most important component of the Internet. The web gives users access to a vast array of documents that are connected to each other by means of links, which are electronic connections that link related pieces of information in order to allow a user easy access to them. Hypertext allows the user to select a word from text and thereby access other documents that contain additional information pertaining to that word; hypermedia documents feature links to images, sounds, animations, and movies.

The web operates within the Internet's basic client-server format; Servers are computer programs that store and transmit documents (i.e., web pages) to other computers on the network when asked to, while clients are programs that request documents from a server as the user asks for them. Browser software allows users to view the retrieved documents. A web page with its corresponding text and hyperlinks is normally written in HTML or XML and is assigned an online address called a Uniform Resource Locator (URL).

### Platform Independent Programming Language

An example of a platform independent programming language is the Java technology platform. A program which utilizes Java technology is composed of a number of classes and interfaces. Unlike many programming languages, in which a program is compiled into machine-dependent, executable program code, programs which utilize Java technology are compiled into machine independent bytecode class files. Each class contains code and data in a platform-independent format called the class file format. The computer system acting as the execution vehicle contains a program called a virtual machine, which is responsible for executing the code in classes. The virtual machine provides a level of abstraction between the machine independence of the bytecode classes and the machine-dependent instruction set of the underlying computer hardware. FIG. 1 is a block diagram illustrating a sample network application environment, for instance a Java technology network application environment, comprising a client platform 102 coupled over a network 101 to a server 100 for the purpose of accessing class files for execution of an application or applet.

### Sample Network Application Environment

In FIG. 1, server 100 comprises development environment 104 for use in creating the class files for a given application. The development environment 104 provides a mechanism, such as an editor and an applet viewer, for generating class files and previewing applets. A set of core classes 103 comprise a library of classes that can be referenced by source files containing other classes. From development environment 104, one or more source files 105 are generated. Source files 105 contain the programmer readable class definitions, including data structures, method implementations and references to other classes. Source files 105 are provided to compiler 106, which compiles source files 105 into compiled “class” files 107 that contain bytecodes executable by a virtual machine. Bytecode class files 107 are stored (e.g., in temporary or permanent storage) on server 100, and are available for download over network 101.

Client platform 102 contains a virtual machine (VM) 111 which, through the use of available native operating system (O/S) calls 112, is able to execute bytecode class files and execute native O/S calls when necessary during execution. Class files are often identified in applet tags within an HTML (hypertext markup language) document. A web server application 108 is executed on server 100 to respond to HTTP (hypertext transport protocol) requests containing URLs (universal resource locators) to HTML documents, also referred to as “web pages.” When a browser application executing on client platform 102 requests an HTML document, such as by forwarding URL 109 to web server 108, the browser automatically initiates the download of the class files 107 identified in the applet tag of the HTML document. Class files 107 are typically downloaded from the server and loaded into virtual machine 111 individually as needed.

It is typical for the classes of a program to be loaded as late during the program's execution as possible; they are loaded on demand from the network (stored on a server), or from a local file system, when first referenced during the program's execution. The virtual machine locates and loads each class file, parses the class file format, allocates memory for the class's various components, and links the class with other already loaded classes. This process makes the code in the class readily executable by the virtual machine.

### Virtual Machine Integration

When developing programs in an environment such as Java environment or another platform independent programming language, there are host application specific problems that arise when trying to integrate the virtual machine. In particular, a developer must deal with the details associated with virtual machine start-up for different platforms. These include setting up environment variables based on the specific runtime environment, loading the correct shared libraries in the correct order, resolving specific symbols, and using specific start-up arguments. This burdens the developer with details that are specific to the host application. Since there are a large number of different host applications, it makes it extremely difficult for a developer to integrate the virtual machine into any specific host application.

In a Java environment, there is a toolkit for developers for use in window environments called the Abstract Window Toolkit (AWT). Integration can become problematic because if the application wishes to cooperate with AWT the native window objects must be passed to AWT for drawing. Also, Java object and native object integration becomes problematic. For sophisticated applications there must also be a way to synchronize execution of Java and native threads. In addition, if it is impossible or undesirable to run the virtual machine in the same process as the host application there must be a speedy and convenient way to perform remote calls.

### SUMMARY OF THE INVENTION

The present invention relates to an API for integrating a virtual machine into a host application. According to one or more embodiments of the present invention, the plug-in traditionally used to implement a virtual machine is partitioned into two categories. A first category contains host application specific information. A second category contains host application independent information and contains the virtual machine itself. This allows a developer to interface with the virtual machine in a manner that is removed from the runtime environment that exists in the host application. This is useful because it allows the developer to make changes to the virtual machine without worrying about compatibility or optimization with specific environments or applications.

In one embodiment, the second category has four main functions. A first function is an API for virtual machine initialization and shutdown, user interface integration, message passing, security hooks, synchronization and extension handling. A second function is an API used to load host application specific code, both native and Java technology code properly, and negotiate shared resources (like capability). A third function is the implementation of libraries in both native and Java code. A fourth function is the implementation of helper libraries (where helper libraries consist of code that is used for integration of the virtual machine into different applications).

From an application point of view, the second category is a shared library which exports only one function JVMP_GetPlugin( ), which returns a pointer to the structure that represents all other functions. In one embodiment, the virtual machine, and hence, the native methods used to integrate the virtual machine with the host application run in the same address space. In another embodiment, the native methods used to integrate the virtual machine with the host application run in a different address space and may communicate via a shared memory transport.

### BRIEF DESCRIPTION OF THE DRAWINGS

These and other features, aspects and advantages of the present invention will become better understood with regard to the following description, appended claims and accompanying drawings where:

FIG. 1 is a diagram of a sample network application environment.

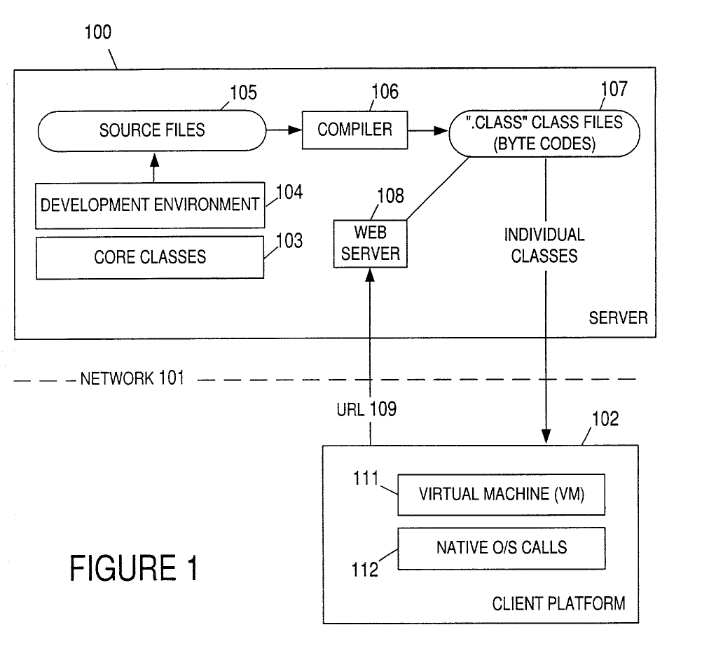

FIG. 2 is a flowchart of a low-level API for integrating a virtual machine into a host application according to an embodiment of the present invention.

FIG. 3 is a flowchart of a low-level API for integrating a virtual machine into a host application according to another embodiment of the present invention.

FIG. 4 a diagram showing virtual machine integration using a common address space according to an embodiment of the present invention.

FIG. 5 a diagram showing virtual machine integration using a shared memory transport according to an embodiment of the present invention.

FIG. 6 shows a virtual machine integration architecture according to an embodiment of the present invention.

### DETAILED DESCRIPTION OF THE INVENTION

The present invention relates to an API for integrating a virtual machine into a host application. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

### Partitioning

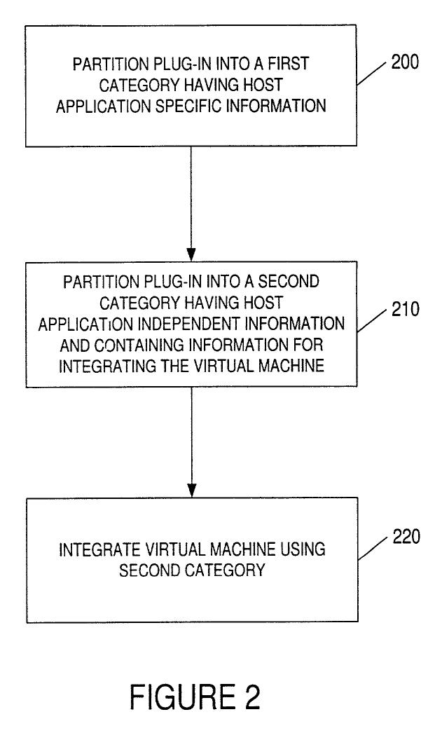

According to one or more embodiments of the present invention, a plug-in is partitioned into two categories. A plug-in is traditionally used to implement an embedded virtual machine. A first partitioned category contains host application specific information. A second category contains host application independent information and contains the virtual machine itself. This allows a developer to interface with the virtual machine in a manner that is removed from the runtime environment that exists in the host application. This embodiment of the present invention is shown in FIG. 2.

At operation 200 the traditional plug-in is partitioned into a first category having host application specific information. Then, at operation 210, the plug-in is partitioned into a second category having host application independent information and containing the information for integrating the virtual machine. Thereafter, at operation 220 a developer uses the second category to integrate the virtual machine in a manner that is completely removed from any host application specific information.

In one embodiment, the second category has four main functions. A first function is an API for virtual machine initialization and shutdown, user interface integration, message passing, security hooks, synchronization and extension handling. A second function is an API used to load host application specific code, both native and Java code properly, and negotiate shared resources (like capability). A third function is the implementation of libraries in both native and Java code. A fourth function is the implementation of helper libraries.

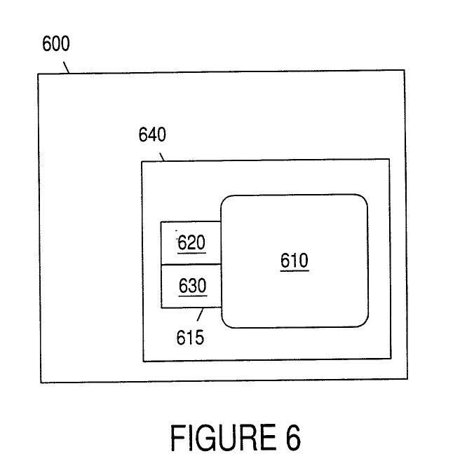

One embodiment of the present invention implements a fixed API between the two categories to allow the implementation of application extensions (such as COM component, plugins, etc.). Appendix A includes a C header file as an example of one embodiment of such a fixed API. Another embodiment of the present invention is shown in FIG. 6. The architecture of FIG. 6 shows a computing environment 600. Computing environment 600 maybe any type of computing environment regardless of operating system and hardware. Computing environment 600 includes a host application 640. The host application 640 may be a web browser or other computer program that uses virtual machine functionality.

The virtual machine 610 is the entity that must be integrated into host application 640. This is done using component 615. Plug-in component 615 is divided into host application independent component 620 and host application dependent component 630. In prior art systems, a developer was forced to deal with the specifics of both components 620 and 630 which made it difficult to integrate the virtual machine 610 into some host applications. Using the architecture shown in the embodiment of FIG. 6, however, host application independent component 620 is used by the developer to interface with host application dependent component 630. Since host application dependent component 630 contains details that differ with each type of host application, an interface to component 630 saves the developer from having to learn specific information about different host applications and makes virtual machine integration much easier.

### Application Side

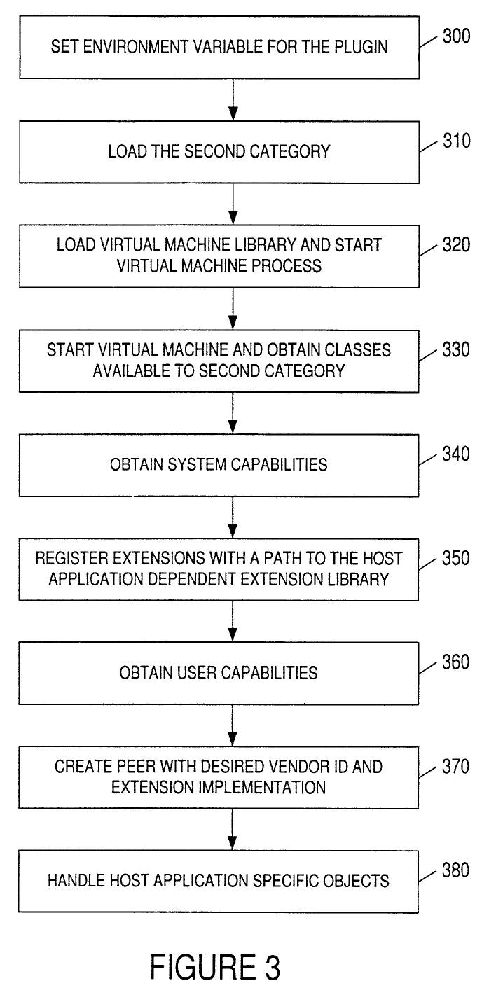

From an application point of view, the second category is a shared library which exports only one function, JVMP_GetPlugin( ). JVMP_GetPlugin( ) returns a pointer to the structure that represents all other functions. It may be used, for example, in the sequence shown in FIG. 3 where at operation 300, the environment variable for the plug-in (or appropriate Widows registry key) is set to the location of the second category (i.e., the category having host application independent information). These environment variables include changeable variables in process address space.

From an application point of view, the second category is a shared library which exports only one function, JVMP_GetPlugin( ). JVMP_GetPlugin( ) returns a pointer to the structure that represents all other functions. It may be used, for example, in the sequence shown in FIG. 3 where at step 300, the environment variable for the plug-in (or appropriate Windows registry key) is set to the location of the second category (i.e., the category having host application independent information). These environment variables include changeable variables in process address space.

To pass the basic configuration, such as a path to the VM wrapping library, different approaches maybe used. In one current reference implementation environmental variables are used, but any other approaches, like configuration files, registry entries may also be used. Environmental variables are chosen in one embodiment as the most portable and easy solution.

At step 310, the second category is loaded. The second category, from the application side is viewed as a shared library or DLL. Loading the second category locates the entry point for the function JVMP_GetPlugin( ). Next, at step 320, a call is made to the JVMP_GetPlugin( ) function which loads the virtual machine library or starts the virtual machine process. Then, at step 330, the virtual machine is started and the classes available in the second category are obtained. Next, the system capabilities required for further operations are obtained at step 340. The system capabilities define the ability to perform system wide actions. The system capabilities provide an entity with the ability to perform an action. An entity can request an extension from a library to allow the entity a capability and the means to authenticate itself. If the authentication is satisfied, the entity gets the ability to perform some action with the library.

Then, the extensions are registered with a path to the host application dependent extension library at step 350. (The extensions allow custom code to be supplied to handle objects specific to the application.) This path contains the Java language native methods of the extension, and extension specific information used by the second category to initialize this extension. Thereafter, the user capabilities are obtained at step 360. Then a peer is created at step 370 with the desired vendor ID and extension implementation version. Finally, host application specific objects are handled at step 380. After completion of operation with a given extension and destruction of all extension specific objects, the extension is typically unregistered.

### Internal Structure

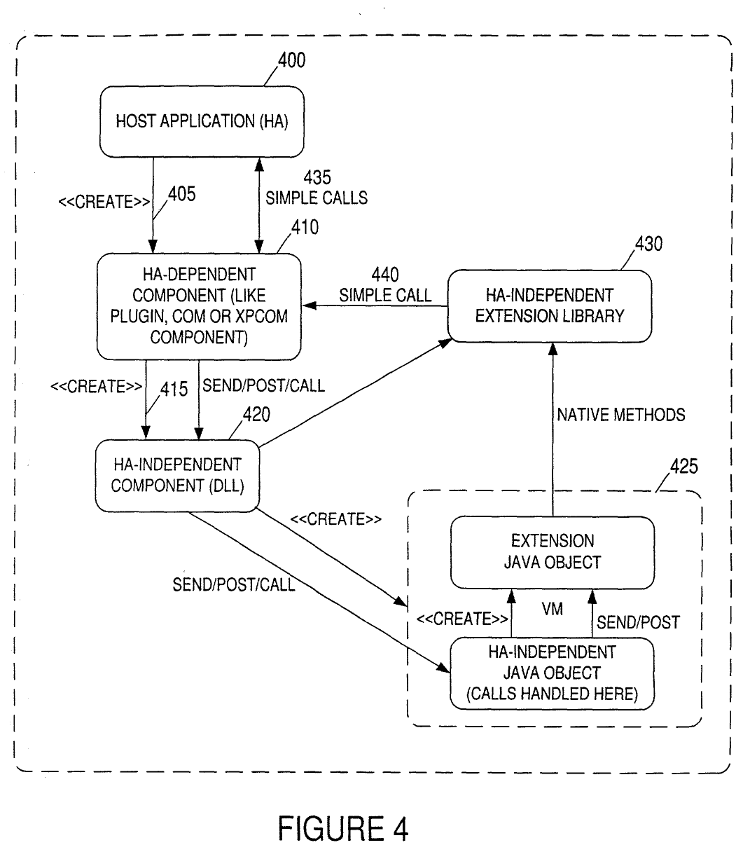

In one embodiment an in-process library is available to extension developers where the host application dependant and host application independent components operate in a common address space. In another embodiment, a remote library is available to extension developers as well that passes requests to the JVM using a shared memory transport. In-process is illustrated by the diagram of FIG. 4. Consider the case where a host application 400 encounters something that requires Java functionality, for instance where the host application 400 is a web browser that encounters an applet. Then, the host application must create a component that handles applets.

To create a component that handles applets, an initialization process occurs where the host application makes a create call 405 (an object pointer) to a host application dependant component 410. The host application dependant component 410 loads, via a create call 415, a host application independent component 420. The host application independent component then internally creates the VM 425 and the host application dependent extension library 430 that is specific for the host application dependant component 410 and the initialization is complete.

Now, consider the case where the host application 400 needs to show the applet. To show the applet, the host application 400 makes a call 435 to the host application dependent component 410 telling it to render the applet with its given parameters. The call maybe performed from C, C++, or another suitable programming language. In response, the host application dependent component 410 uses the host application independent component 420 to create an applet. Component 420 calls the host application dependent extension 430. The extension 430 calls back if it needs additional information. When the applet needs functionality from the host application (i.e., web browser) it calls the proper extension method which calls the host application dependent component.

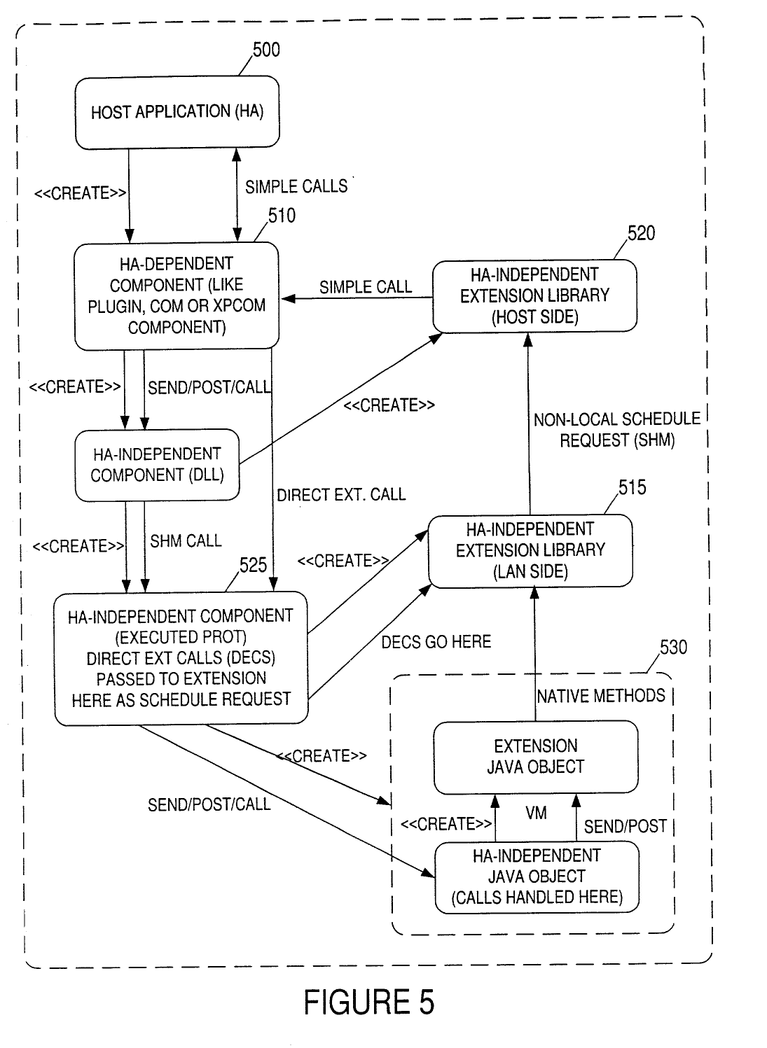

The remote library is shown in FIG. 5 where there is not a common address space between host application dependent and independent components. This diagram is similar to FIG. 4, but host application independent component 500 cannot make calls directly into host application dependent component 510 because they exist in different address spaces. In this case there must be a common method to communicate between the extension library on the VM side 515 and the extension library on the host side 520.

To do so, host application independent component 500, when needed, creates a separate process 525, which has the VM 530 inside and uses shared memory as the transport medium. Then, host application calls are similar, except, when a non-trivial call is made from the VM side 515, it cannot be handled directly as a message. Instead a remote bridge is created for a direct extension call. (The remote bridge operates bypassing arguments by reference (i.e. address) to a called object, solving the problem where there is no common address space). Without common address space pointers from one process are invalid in another, thus, in a two-process case everything that is needed must be passed by value. For two process cases, a special channel is needed to assist the host application in handling asynchronous VM side requests. In one embodiment, a listener on a message queue (or on another transport) is used.

Thus, an API for integrating a virtual machine into a host application is described in conjunction with one or more specific embodiments. The invention is defined by the claims and their full scope of equivalents.

APPENDIX A
methods.txt

All methods gathered into single structure. Waterfall library itself
exports only one method
JNIEXPORT int JNICALL JVMP_GetPlugin(JVMP_RuntimeContext** cx);
that returns structure in question.
Follows short description of methods and fields:
struct JVMP_RuntimeContext {

/**

* JVM associated with this JVMP object - in some implementations
* may be zero, so you shouldn't rely on this value heavily.
*/

JavaVM* jvm;
/**

* Return description of this plugin, including:
* underlying JVM version, underlying JVM vendor, vendor-dependent data,
* JVMP version - for details see jvmp_vendor.h. You shouldn't do memory
* management on returned value - it's statically allocated
*/

jint (JNICALL *JVMP_GetDescription) (JVMP_PluginDescription* *pdesc);
/**

* Does all dirty work on loading and starting Java VM
* with correct arguments args can be used to pass JVM-specific arguments,
* usually NULL is OK.
* Argument allow_reuse, if JNI_TRUE allow to use
* already running JVM for plugin purposes May be dangerous,
* if running JVM is not the same that plugin is compiled for.
* Also plugin system classes must be in classpath of this JVM, as current
* JVM specification doesn't allow change classpath after running JVM
* As additional effect, sets jvm field in JVMP_PluginContext to
* currently running JVM.
*/

jint (JNICALL *JVMP_GetRunningJVM) (JVMP_CallingContext* *pctx,

void* args,
jint allow_reuse),

/**

* Send generic event directly to PluggableJVM Can be used to
* extend Waterfull APT without changing ABI, like loctl() syscall on Unix
* Exact time of call execution depends on “priority”
* and current state of event queue. At this point I would like to freeze
* jvmp.h, and all further API extensions should be done using those
* two calls.
* Every WF implementation can have its own set of commands, but suggested
* minimum can be found in jvmp_event.h, see JVMP_CMD_8.
*/

jint (JNICALL *JVMP_SendSysEvent) (JVMP_CallingContext* ctx,

jint event,
jlong data,
jint priority);

/**

* Async system call. Exact time of call execution depends on “priority”
* and current state of event queue.
*/

jint (JNICALL *JVMP_PostSysEvent) (JVMP_CallingContext* ctx,

jint event,
jlong data,
jint priority);

/**

* Should stop and unload Java VM - not well implemented in JDK1.3 yet.
*/

jint (JNICALL *JVMP_CallingContext* ctx);
/**

* Registers native window handle (OS dependent, see jvmp_drawing h) in
* AWT, if succeed you can use PluggableJVM getFrameWithId() method with
* returned id (>0) to obtain this frame on Java side
*/

jint (JNICALL *JVMP_RegisterWindow) (JVMP_CallingContext* ctx,

JVMP_DrawingSurfaceInfo* win,
jint *pID);

/**

* Unregisters native window, ID is invalid after this call.
*/

jint (JNICALL *JVMP_UnregisterWindow) (JVMP_CallingContext* ctx,

jint ID);

/**

* Thread synchronization primitives
*/

/**

* Registers native monitor object (OS dependent, see jvmp_threading.h) in JVM
* if succeed you can use PluggableJVM.getSynchroObjectWithID()
* to obtain SynchroObject, calling _wait (), _notify ().
* _notifyAll () on this object will perform those operation on monitor you
* passed. It leads to obvious granularity problems, but all operations
* must be pretty fast, and it works reasonable.
* In the future, JVM could provide hooks, so it will be posible to use
* JVMP_MonitorInfo to construct java.lang.Object with passes locks and
* monitors, and so Java code shouldn't care about source of synchroobject.
* Now it would require too much JDK work, so using easiest solution.
*/

jint (JNICALL *JVMP_RegisterMonitorObject) (JVMP_CallingContext* ctx,

JVMP_MonitorInfo* monitor,
jint *pID);

/**

* Unregister monitor and destroy associated objects
*/

jint (JNICALL *JVMP_UnregisterMonitorObject) (JVMP CallingContext* ctx,

jint ID);

/**

* Attaches current thread to JVM Creats java lan, Thread for given thread,
* and register this thread in PluggableJVM, so you can reference it using
* method getThreadWithId().
* All synchrooperations must happen only arter JVMP AttachThread call
* otherwise error is returned Really, JVMP GetRunningJVM and JVMP Get Calling

Context

* call JVMP AttachCurrentThread, so usually you shouldn't care
*/

jint (JNICALL *JVMP_AttachCurrentThread) (JVMP_CallingContext * ctx,

jint *pID),

/**

* Detaches current thread from JVM
* This function must be called by native thread before
* finishing all JVMP operations, as there's no generic way to register
* listener on thread exit - pthread cleanup push() is a stupid macros working
* in one block only.
* Also this call frees memory consumed by ctx, so ctx is invalid after this c

all.

*/

jint (JNICALL *JVMP_DetachCurrentThread) (JVMP_CallingContext* ctx),
/**

* Gets calling context for further JVMP * operation also can be obtained fr

om

* GetRunningJVM call Every such call would create new context with default
* parameters, so usually you have to call it once per thread.
*/

jint (JNICALL *JVMP_GetCallingContext) (JVMP_CallingContext* *pctx);
/**

* Extensible event passing(invocation) API.
*/

/**

* Create peer (Java object) as event target.
* vendorID - is unique for application number,
* version should be desired version, or 0 if doesn't matter
* Usually created object is just a wrapper, able to mimic
* more specific HA-dependent objects. Way of object negotiation
* is HA-specific.
* ID returned back can be considered as opaque handle
* for further sync/async event and destroy.
*/

jint (jnicall *jvmp_CreatePeer) (JVMP_CallingContext* ctx,

jint vendorID,
jint version,
jint *target);

/**

* Send an synchronous event to Java peer with some data.
* Waterfall protocol dosen't specify protocol of event passing,
* and format of passe data, it just provides transport,
*/

jint (JNICALL *JVMP_SendEvent) (JVMP_CallingContext* ctx,

jint target,
jint event,
jlong data,
jint priority);

/**

* Send an asynchronous event to Java peer with some data.
* Waterfall protocol doesn't specify protocol of event passing,
* lifetime and format of passed data, it just provides transport
*/

jint (JNICALL *JVMP_PostEvent) (JVMP_CallingContext* ctx,

jint target,
jint event,
jlong data,
jint priority);

/**

* Destroy Java peer with given ID.
* All pending events will be lost.
*/

jint (JNICALL *JVMP_DestroyPeer) (JVMP_CallingContext* ctx,

jint target);

/**

* Register Waterfall extension DLL (see jvmp_extension.h).
* If succeed, after this call, you can use JVMP_CreatePeer
* with vendorID provided by this extension DLL.
* Maybe Unicode string is better, but not sure yet.
* “data” is arbitrary associated with this extension, passed
* to the start () method of extension.
*/

jint (JNICALL *JVMP_RegisterExtension) (JVMP_CallingContext* ctx,

const char* extPath,
jint *pID,
jlong data);

/**

* Send/post event to extension-wide bootstrap class - see
* JVMPExt_GetBootstrapClass() in jvmp_extension.h.
* Could be useful, if ones wish to cooperate with whole extension,
* not only any given peer. “target” is extension ID returned
* by JVMP_RegisterExtension.
*/

jint (JNICALL *JVMP_SendExtensionEvent) (JVMP_CallingContext* ctx,

jint target,
jint event,
jlong data,
jing priority);

jint (JNICALL *JVMP_PostExtensionEvent) (JVMP_CallingContext* ctx,

jint target,
jint event,
jlong data,
jint priority);

/**

* Unregister Waterfall extension DLL.
*/

jint (JNICALL *JVMP_UnregisterExtension) (JVMP_CallingContext* ctx,

jint ID);

/**

* Capabilities handling. To perform privileged actions,
* application must have capability to do it. Those calls intended
* to change capabilities of current calling context.
* It's up to HA extension and JVMP to permit/forbid capability changing,
* using provided principal.
* ctx and principal much like username/password pair.
*/

/**

* Tries to enable caps, authecticating with principals
* On success ctx updated with asked caps, otherwise nothing happens
* and JNI_FALSE returned Arbitrary set of byte arrays can be used as
* principal.
*/

jint (JNICALL *JVMP_EnableCapabilities) (JVMP_CalllingContext* ctx,

JVMP SecurityCap* caps,
jint num principals,
jint* principals len,
jbyte* *principals);

/**

* Drop some capabilities Some system caps (like JVMP CAP SYS PARITY)
* Cannot be dropped
*/

jint (JNICALL *JVMP_DisableCapabilities) (JVMP_CallingContext* ctx,

JVMP_SecurityCap* caps);

).
Ha-dependent extend ability is provided using extensions mechanism.
Every extension is shared library that exports this function
typedef JNIEXPORT jint JNICALL JVMP GetExtension_) (JVMP Extension** ext);
where argument is
struct JVMP.Extension (

/**

* Init native part of this extension
* Argument is side on which extension is loaded, if in
* separate process situation (0 not separate process case
* 1 - host side, 2 JVM side)
*/

jint (JNICALL *JVMPExt Init) (jint side),
/**

* Shutdown this extension Usually means nobody wants it anymore
*/

jint (JNICALL *JVMPExt Shutdown) ().
/**

* the only function which can be called before Init
* pID - vendor ID, pVersion - version of handler
*/

jint (JNICALL *JVMPExt_GetExtInfo)(jint *pID, jint *pVersion);
/**

* Return classpath to find bootstrap Java class, and its name
* Classpath is “I”-separated list of URLs, like
* jar:file:///usr/java/ext/mozilla/moz6_ext.jarlfile:///usr/java/ext/mozilla/

classes|http://www.mozilla.org/Waterfall/classes

* Name is smth like: sun.jvmp.mozilla.MozillaPeerFactory

*/
jint (JNICALL *JVMPExt_GetBootstrapClass) (char* *bootstrapClassPath,

char* *bootstrapClassName);

/**

* This is extension's callback to schedule request in host
* in different proc or STA situation.
* Different methods executed depending
* on funcno in request, use macros to numerate your functions.
* JVMP_NEW_EXT_FUNCNO (vendorID, funcno). Implementation of this callback
* is application/platform dependent. It can be implemented using
* XtAddEventHandler on X, SendMessage on Win32.
* If local -- JNI_TRUE - just execute this request locally.
*/

jint (JNICALL *JVMPExt_ScheduleRequest) (JVMP_ShmRequest* req, jint local);
/**

* This function reserves capabilities space for this extension
* Arguments are two caps bitfields - first one is et of capabilities this
* extension is interesting, and second describes sharing policy on this set
* of caps:
* if bit set - this cap is to be shared.
* After this call for all decisions on caps in this range
* delegated to AccesControlDecider of this extension.
* Arguments are two caps bitfields - first one is set of capabilities this
* extension is intersting, and second describes sharing policy on this set
* of caps:
* if bit set - this cap is to be shared.
* After this call for all decisions on caps in this range
* delegated to AccessControlDecider of this extenion.
* If access to capability range is shared, then Waterfall chains
* all deciders for given capability, if anyone forbids capability setting
* - this capability no granted.
*/

jint (JNICALL *JVMPExt_GetCapsRange) (JVMP_SecurityCap* caps,

JVMP_SecurityCap* sh_mask);

);
For Java side, every extensions get argument PluggableJVM when created with
following public methods
/**

* Returns frame, registered with given ID, see JVMP_RegisterWindow().
*/

public Frame getFrameWithId(int id);
/**

* Returns object created with given ID, see JVMP_CreatePeer
**/

public HostObjectPeer getPeerWithId(int id);
/**

* Returns extension registered with given ID, see JVMP_RegisterExtension()
**/

public HostObjectPeerFactory getFactoryWithId(int id);
/**

* Returns thread attached with given id, see JVMP_AttachThread()
**/

public Thread getThreadWithId(int id);
/**

* Returns synchro object registered with given ID,
* see JVMP_RegisterMonitorObject
**/

public SynchroObject getSyrchroObjectWithID(int id);
Using those methods Java and native part of program of application can
successfully interoperate.

1. A method for integrating an application program interface into a virtual machine comprising:
dividing a plug in into a first and second component wherein said first component has only host application specific information and said second component has only host application independent information; and
integrating said virtual machine using said second component.

2. The method of claim 1 wherein said virtual machine is a Java virtual machine.

3. The method of claim 1 wherein said first and second components use a common address space.

4. The method of claim 1 wherein said first and second components do not use a common address space.

5. The method of claim 4 wherein said first and second components communicate via a shared memory transport.

6. A computer program product comprising:
a computer usable medium having computer readable program code embodied therein configured to integrate an application program interface into a virtual machine, said computer program product comprising:
computer readable code configured to cause a computer to divide a plug in into a first and second component wherein said first component has only host application specific information and said second component has only host application independent information; and
computer readable code configured to cause a computer to integrate said virtual machine using said second component.

7. The computer program product of claim 6 wherein said virtual machine is a Java virtual machine.

8. The computer program product of claim 6 wherein said first and second components use a common address space.

9. The computer program product of claim 6 wherein said first and second components do not use a common address space.

10. The computer program product of claim 9 wherein said first and second components communicate via a shared memory transport.

11. A virtual machine integration comprising:
a plug in divided into a first and second component wherein said first component has only host application specific information and said second component has only host application independent information; and
a virtual machine configured to be integrated using said second component.

12. The virtual machine integration of claim 11 wherein said virtual machine is a Java virtual machine.

13. The virtual machine integration of claim 11 wherein said first and second components use a common address space.

14. The virtual machine integration of claim 11 wherein said first and second components do not use a common address space.

15. The virtual machine integration of claim 14 wherein said first and second components communicate via a shared memory transport.

16. A system for using an application program interface to integrate a virtual machine into a host application comprising:
a plug in divided into a first and second component wherein said first component has only host application specific information and said second component has only host application independent information; and
said virtual machine configured to be integrated into said host application using said second component.

17. The system of claim 16 wherein said virtual machine is a Java virtual machine.

18. The system of claim 16 wherein said first and second components use a common address space.

19. The system of claim 16 wherein said first and second components do not use a common address space.

20. The system of claim 19 wherein said first and second components communicate via a shared memory transport.
